(19) United States
(12) Patent Application Publication
(10) Pub. No.: US 2010/0317353 A1
(43) Pub. Date: Dec. 16, 2010

(54) TELECOMMUNICATIONS NETWORK AND TELECOMMUNICATIONS DEVICE

(75) Inventor: Curtis Nash, Bursledon (GB)

Correspondence Address: Schwabe Williamson & Wyatt;PACWEST CENTER, SUITE 1900, 1211 SW FIFTH AVENUE, PORTLAND, OR, 97204, US

(73) Assignee: COMPLIANT PHONES LIMITED, London (GB)

(21) Appl. No.: 12/744,910

(22) PCT Filed: Nov. 26, 2008
(86) PCT No.: PCT/GB08/03929

§ 371 Date: Sep. 1, 2010

(30) Foreign Application Priority Data
Nov. 28, 2007 (GB) 0723298.6

(51) Int. Cl. H04W 40/00; H04W 88/02

(52) U.S. Cl. 455/445; 455/550.1

(57) ABSTRACT

A telecommunications network comprises an electronic call centre, and a telecommunications device operative to transmit and receive data over the network to/from a desired location. The telecommunications device is provided with routing means operative to route data transmissions between the telecommunications device and the desired location to the electronic call centre. The electronic call centre is operative to store a copy of the data transmission.

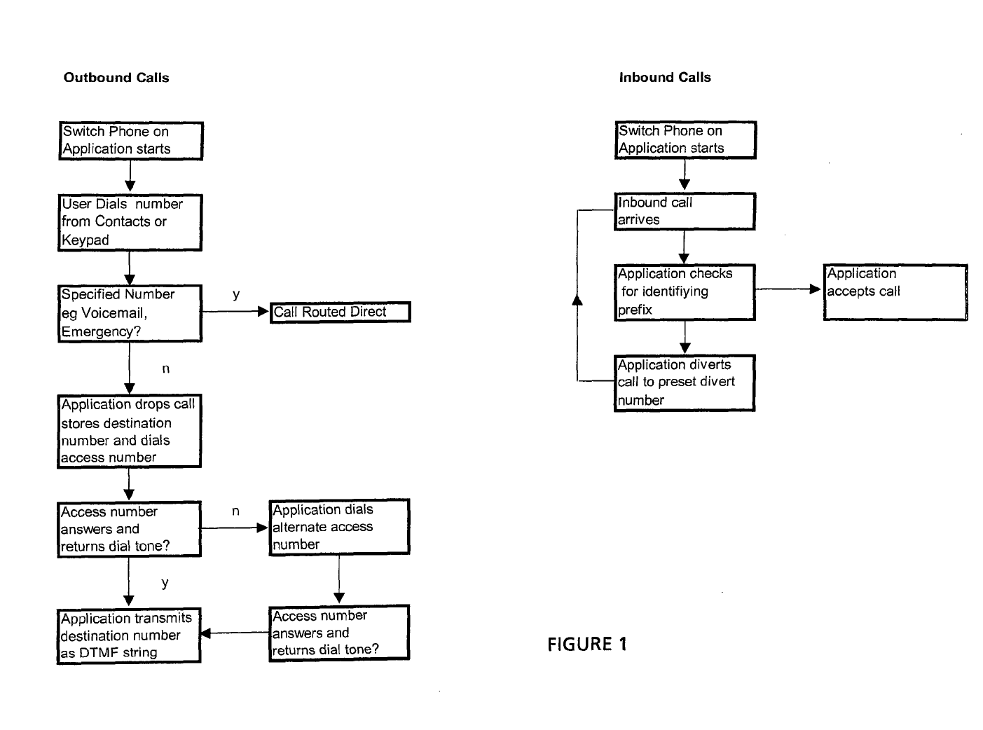

The present invention relates to a telecommunications network and telecommunications device and particularly but not exclusively relates to a telecommunications network for transmitting data, such as telephone calls or SMS/MMS messages for example, to and from a telecommunications device such as a mobile telephone or PDA.

It is often desirable for telephone data transmissions, such as telephone conversations or SMS, MMS and multimedia messages, to be recorded. This may be, for example, for security purposes, for quality management purposes, or for evidential purposes after a crime or other event. For example, financial institutions often wish to record and review telephone conversations between their employees and customers. Likewise the emergency services and transport operators may wish to review a telephone conversation that occurred prior to a crime or a vehicle accident for example. These entities may also wish to record and review data transmissions within those entities, ie between a police officer and his station for example.

Data transmissions such as telephone conversations have typically been recorded using a microphone in the phone that is electrically connected to a data recorder such as a cassette recorder or PC at the location of the telephone. This is unwieldy and not appropriate in many situations particularly but not exclusively when the person concerned is on the move, or in a remote location, or where the destination of each data transmission is not the same.

According to a first aspect of the invention there is provided a telecommunications network comprising an electronic call centre, and a telecommunications device operative to transmit and receive data over the network to/from a desired location, the telecommunications device being provided with routing means operative to route data transmissions between the telecommunications device and the desired location to the electronic call centre, the electronic call centre being operative to store a copy of the data transmission, wherein the electronic call centre is operative to generate an identifier and to attach this identifier to an incoming data transmission routed via the electronic call centre to the mobile telecommunications device.

The identifier may include for example, all or part of the CLI (Caller Line Identification) of the incoming or outgoing telecommunications device, or the CLI with a prefix or suffix, and such an identifier may be cached on the routing means.

Preferably the routing means is operative to route the data transmission via the electronic call centre prior to the data transmission reaching the user of the telecommunications device or the desired location as appropriate.

Preferably the telecommunications device is a mobile telecommunications device.

Preferably the routing means is operative to route data transmissions automatically during use of the mobile telecommunications device such that no active intervention by the user of the device is required.

Preferably the routing means is operative to select which data transmissions are routed.

Preferably, when the telecommunications device is transmitting a data transmission, the routing means is operative to end the outgoing data transmission to the original location destination, and to dial a preset access code of the electronic call centre.

The routing means may, in one example, be operative to transmit an identification of the original location destination to the electronic call centre if the routing means receives a dial tone from the electronic call centre as a result of the access code being dialled.

Preferably the routing means is operative to dial an alternative access code of the electronic call centre should no dial tone be received from the electronic call centre as a result of the first access code being dialled.

Preferably the routing means is operative to route an incoming data transmission back via the electronic call centre should the incoming data transmission not comprise the identifier.

The routing means may be operative, where the data transmission comprises a precreated data transmission, to forward a copy of the incoming or outgoing procreated data transmission to the electronic call centre.

By ‘precreated data transmission’ we mean that the transmission does not vary over time, ie the data transmission is created and then transmitted. Thus by ‘precreated data transmission’ we mean an SMS, MMS or multimedia message rather than a real time data transmission such as a telephone conversation.

According to a second aspect of the invention there is provided a telecommunications device operative to transmit and receive data over a network to/from a desired location, the telecommunications device comprising routing means operative to route data transmissions between the telecommunications device and the desired location to an electronic call centre, the electronic call centre being operative to store a copy of the data transmission wherein the routing means is operative to process an identifier generated by the electronic call centre and attached to an incoming data transmission indicative of the incoming data transmission having been routed via the electronic call centre.

Preferably the routing means is operative to route the data transmission via the electronic call centre prior to the data transmission reaching the user of the telecommunications device or the desired location as appropriate.

Preferably the telecommunications device is a mobile telecommunications device.

Preferably the routing means is operative to route data transmissions automatically during use of the mobile telecommunications device such that no active intervention by the user of the device is required.

Preferably the routing means is operative to select which data transmissions are routed.

Preferably, when the telecommunications device is transmitting a data transmission, the routing means is operative to end the outgoing data transmission to the original location destination, and to dial a preset access code of the electronic call centre,

Preferably the routing means is operative to transmit an identification of the original location destination to the electronic call centre if the routing means receives a dial tone from the electronic call centre as a result of the access code being dialled.

Preferably the routing means is operative to dial an alternative access code of the electronic call centre should no dial tone be received from the electronic call centre as a result of the first access code being dialled.

Preferably the routing means is operative to route an incoming data transmission back via the electronic call centre should the incoming data transmission not comprise an identifier indicative that the data transmission has been routed to the electronic call centre.

The routing means may be operative, where the data transmission comprises a precreated data transmission, to forward a copy of the incoming or outgoing precreated data transmission to the electronic call centre.

Other aspects of the present invention may include any combination of the features or limitations referred to herein.

The present invention may be carried into practice in various ways, but embodiments will now be described by way of example only with reference to the accompanying drawing which comprises an exemplary flow diagram of a network in accordance with the present invention.

A mobile telecommunications network comprises an electronic call centre, or gateway, and at least one telecommunications device such as a land based telephone, a mobile telephone, or a PDA for example. The network will be described, in the following example, with reference to a mobile telephone.

The mobile telecommunications device is provided with routing means that may comprise software code stored on the device, or hardware provided on the device.

The routing means is operative to route incoming or outgoing real time data transmissions such as telephone calls to the electronic call centre prior to the data transmissions reaching the user of the telecommunication device. The routing means may be operative to route telephone calls via the electronic call centre and/or to forward copies of precreated data transmissions such as SMS messages to the electronic call centre.

In use, if the user of the mobile phone wishes to make a telephone call, the user switches the mobile phone on and dials the desired number, either directly from the phone key pad, or with reference to the contacts stored on the phone. So the operation of the mobile phone from the user's point of view is as normal.

The routing means then checks the dialled number to determine if this matches any numbers prestored on the routing means as being numbers that do not require routing to the electronic control centre, for example, emergency telephone numbers or voicemail numbers.

If the dialled number matches a prestored number then the routing means enables the call to be connected directly without being routed via the electronic call centre.

If the dialled number does not match a number prestored on the routing means, the routing means stores the dialled destination number and instead dials an access number, the access number permitting data transmission between the mobile phone and the electronic call centre.

If the dialling of the access number is successful, the mobile phone is connected to the electronic call centre.

If the dialling of the access code is unsuccessful, the routing means dials an alternative access code which, if successful, also connects the mobile phone to the electronic call centre.

When the mobile phone is connected to the electronic call centre, the routing means transmits the originally dialled number to the electronic call centre as a DTMF string identification which is then dialled by the electronic call centre to connect the electronic call centre to the originally dialled destination. Thus the mobile phone is ultimately connected to the originally dialled destination via the electronic call centre and the user may thus talk to the person at the originally dialled destination as normal. The electronic call centre is operative, when so connected, to record the conversation that occurs and to store that conversation in a coded data file.

In order to review a stored data transmission, a third party may subsequently access the electronic call centre by dialling another number and entering a security code particular to the identity of the third party concerned.

In the case of a data transmission incoming to the mobile phone, the routing means is operative to check whether or not the incoming data transmission includes an identifier comprising a code generated by the electronic call centre, the identifier being indicative that the incoming data transmission has been routed via the electronic call centre.

If no such identifier is detected by the routing means then the routing means is operative to divert the incoming data transmission via the electronic call centre. The mobile phone is then connected to the location of the data transmission via the electronic call centre which is operative to record and store the, for example, telephone call for subsequent access by a third party.

The above described process can also be used for precreated data transmissions such as SMS messages.

Alternatively the routing means can forward a sent or received precreated data transmission to the electronic call centre which again, is operative to store the forwarded data transmission for later review by a third party.

Thus the invention provides a mobile telecommunications gateway through which incoming and outgoing data transmissions are routed and stored for subsequent access and review.

1. A telecommunications network comprising an electronic call centre, and a telecommunications device operative to transmit and receive data over the network to/from a desired location, the telecommunications device being provided with routing means operative to route data transmissions between the telecommunications device and the desired location to the electronic call centre, the electronic call centre being operative to store a copy of the data transmission.

2. The telecommunications network and device of claim 1 wherein the routing means is operative to route the data transmission via the electronic call centre prior to the data transmission reaching the telecommunications device or the desired location as appropriate.

3. The telecommunications network and device of claim 1 or 2 wherein the telecommunications device is a mobile telecommunications device.

4. The telecommunications network and device of claim 3 wherein the routing means is operative to route data transmissions automatically during use of the mobile telecommunications device such that no active intervention by the user of the device is required.

5. The telecommunications network and device of any one of claims 1 to 4 wherein the routing means is operative to select which data transmissions are routed.

6. The telecommunications network and device of any one of claims 1 to 5 wherein when the telecommunications device is transmitting a data transmission, the routing means is operative to end the outgoing data transmission to the original location destination, and to dial a preset access code of the electronic call centre.

7. The telecommunications network and device of claim 6 wherein the routing means is operative to transmit an identification of the original location destination to the electronic call centre if the routing means receives a dial tone from the electronic call centre as a result of the access code being dialled.

8. The telecommunications network and device of claim 6 or 7 wherein the routing means is operative to dial an alternative access code of the electronic call centre should no dial tone be received from the electronic call centre as a result of the first access code being dialled.

9. The telecommunications network and device of any one of claims 3 to 8 wherein the electronic call centre is operative to generate an identifier and to attach this identifier to an incoming data transmission routed via the electronic call centre to the mobile telecommunications device.

10. The telecommunications network and device of claim 9 wherein the routing means is operative to route an incoming data transmission back via the electronic call centre should the incoming data transmission not comprise the identifier.

11. The telecommunications network and device of any one of claims 1 to 10 wherein the routing means is operative, where the data transmission comprises a precreated data transmission, to forward a copy of the incoming or outgoing precreated data transmission to the electronic call centre.

12. A telecommunications device operative to transmit and receive data over a network to/from a desired location, the telecommunications device comprising routing means operative to route data transmissions between the telecommunications device and the desired location to an electronic call centre, the electronic call centre being operative to store a copy of the data transmission.

13. The telecommunications device of claim 12 wherein the routing means is operative to route the data transmission via the electronic call centre prior to the data transmission reaching the telecommunications device or the desired location as appropriate.

14. The telecommunications device of claim 12 or 13 wherein the telecommunications device is a mobile telecommunications device.

15. The telecommunications device of claim 14 wherein the routing means is operative to route data transmissions automatically during use of the mobile telecommunications device such that no active intervention by the user of the device is required.

16. The telecommunications device of any one of claims 12 to 15 wherein the routing means is operative to select which data transmissions are routed.

17. The telecommunications device of any one of claims 12 to 16 wherein when the telecommunications device is transmitting a data transmission, the routing means is operative to end the outgoing data transmission to the original location destination, and to dial a preset access code of the electronic call centre.

18. The telecommunications device of claim 17 wherein the routing means is operative to transmit an identification of the original location destination to the electronic call centre if the routing means receives a dial tone from the electronic call centre as a result of the access code being dialled.

19. The telecommunications device of claim 17 or 18 wherein the routing means is operative to dial an alternative access code of the electronic call centre should no dial tone be received from the electronic call centre as a result of the first access code being dialled.

20. The telecommunications device of any one of claims 12 to 19 wherein the routing means is operative to route an incoming data transmission back via the electronic call centre should the incoming data transmission not comprise an identifier indicative that the data transmission has been routed to the electronic call centre.

21. The telecommunications device of any one of claims 12 to 20 wherein the routing means is operative, where the data transmission comprises a precreated data transmission, to forward a copy of the incoming or outgoing precreated data transmission to the electronic call centre.

22. A telecommunications network and device substantially as described herein and as shown in the accompanying drawings.

23. A telecommunications device substantially as described wherein and as shown in the accompanying drawings.
